(19) United States
(12) Patent Application Publication
(10) Pub. No.: US 2003/0105846 A1
(43) Pub. Date: Jun. 5, 2003

(54) Enhanched UDDI with service push model

(75) Inventors: Luyin Zhao, Briarcliff Manor, NY (US); Jin Lu, Croton-on-Hudson, NY (US); Kwok Pun Lee, Flushing, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/015,708

(22) Filed: Nov. 30, 2001

(51) Int. Cl. G06F 15/173; G06F 15/16; G06F 15/177

(52) U.S. Cl. 709/221; 709/219; 709/225

(57) ABSTRACT

A method for obtaining service information over the Internet. The method including: at least one service provider registering a service and corresponding service status with a server and storing the same in a database; a user requesting a service from the server; searching the database for the requested service; and informing the user of the results of the search. If the requested service is found in the database, the user is informed of the corresponding service status of the requested service. Similarly, if the requested service is not found in the database, the user is informed of the same. If the requested service is not found in the database, or the service status for the requested service is unavailable, the request is stored and the user is informed when the service becomes registered or the service status is changed to available.

### BACKGROUND OF THE INVENTION

1. Field of the Invention

The present invention relates generally to methods and systems for obtaining service information over the Internet, and more particularly, to an enhanced UDDI (Universal Description, Discovery, and Integration) based Web service push model.

2. Prior Art

UDDI based Web Service is a new distributed interoperability paradigm that emerged a year ago. UDDI stores information about businesses anywhere on the Internet and descriptions of their services. With Register and Discover interfaces provided by UDDI, service providers can register themselves and service users are able to find desired providers and invoke services (WSDL: Web Service Description Language is used to describe services with a uniform format).

Currently, UDDI only supports the “pull model”, that is, the only operation a client can do is to find desired service providers who are already registered in the UDDI registry, and then make the invocation to the services offered by the service providers using the invocation methods provided by UDDI. This process is considered a “pull” model because the client can only actively look for available services.

However, in many cases, clients may not be able to find the desired service immediately because the service providers are not registered. In this case, clients want to be notified of new services once they are available. Or, a client knows who provides the service, but the service is not available for some reasons or only works at a certain time.

### SUMMARY OF THE INVENTION

Therefore it is an object of the present invention to provide a method and system for obtaining service information over the Internet, which overcomes the problems associated with the prior art.

It is another object of the present invention to provide a method and system for obtaining service information over the Internet, which notifies a user when a previously unavailable or unregistered service becomes available or registered, respectively.

Accordingly, a method for obtaining service information over the Internet is provided. The method comprises: at least one service provider registering a service with a server and storing the same in a database; a user requesting a service from the server; initially searching the database for the requested service; updating the database; subsequently searching the updated database for the requested service; and notifying the user of the results of the subsequent search.

Preferably, the method further comprises notifying the user of the results of the initial search. Either of the notifying preferably comprises sending an e-mail to the user. Where the registering further comprises registering a corresponding service status for the service, and if the requested service is found in the database from either the initial or the subsequent search, the corresponding notifying preferably comprises informing the user of the corresponding service status of the requested service. If the requested service is not found in the database from either the initial or the subsequent search, the corresponding notifying preferably comprises informing the user that the requested service is not registered with the server.

The method preferably further comprises storing the request for the service in the database for the subsequent search in which case the user is notified that the service request has been stored. The notifying that the service request has been stored preferably comprises sending an e-mail to the user indicating the storage of the service request.

Where the registering further comprises registering a corresponding service status for the service and if the requested service is found on the server in the initial search and the service status indicates that the service is available, the corresponding notifying of the initial search results preferably comprises informing the user that the requested service is available. If the requested service is found on the server in the initial search and the service status indicates that the service is unavailable, the corresponding notifying of the initial search results preferably comprises informing the user that the requested service is unavailable. In which case, the method preferably further comprises storing the request for the service in the database and notifying the user that the service request has been stored. The notifying that the service request has been stored preferably comprises sending an e-mail to the user indicating the storage of the service request.

Where the registering further comprises registering a corresponding service status for the service and if the requested service is not found on the server in the initial search but found in the subsequent search and the service status indicates that the service is available, the notifying of the subsequent search results preferably comprises informing the user that the requested service has been found in a subsequent search and is available. If the requested service is not found on the server in the initial search but found in the subsequent search and the service status indicates that the service is unavailable, the notifying of the subsequent search results preferably comprises informing the user that the requested service has been found in a subsequent search and is unavailable.

Preferably, the updating comprises permitting at least one additional service provider to register with the server. Where the registering further comprises registering a corresponding service status for the service, the updating preferably comprises permitting the at least one service provider to change the corresponding service status.

Also provided is a system for obtaining service information over the Internet. The system comprises: a server having a memory operatively connected thereto for storing a database of services by service providers; means for receiving a request for a service by a user; means for initially searching the database for the service request; means for updating the database; means for subsequently searching the updated database for the requested service; and means for notifying the user of the results of the subsequent search.

Preferably, the method further comprises means for notifying the user of the results of the initial search where either of the means for notifying preferably comprises means for generating an e-mail and transmitting the same to the user.

Preferably, the method further comprises a memory for storing the request if the requested service is not found in the database in the initial search.

The means for updating preferably comprises means for permitting at least one additional service provider to register with the server. Where the at least one service provider further registers a corresponding service status for the service, the means for updating comprises means for permitting the at least one service provider to change the corresponding service status.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a flowchart of a preferred implementation of the methods of the present invention.

FIG. 2 illustrates flowchart branches A and B of the flowchart of FIG. 1.

FIG. 3 illustrates a schematic of a system of the present invention for practicing the methods of FIGS. 1 and 2.

FIG. 4 illustrates a UML (Unified Modeling Language) sequence diagram for Example 2.

### DETAILED DESCRIPTION OF THE PREFERRED EMBODIMENT

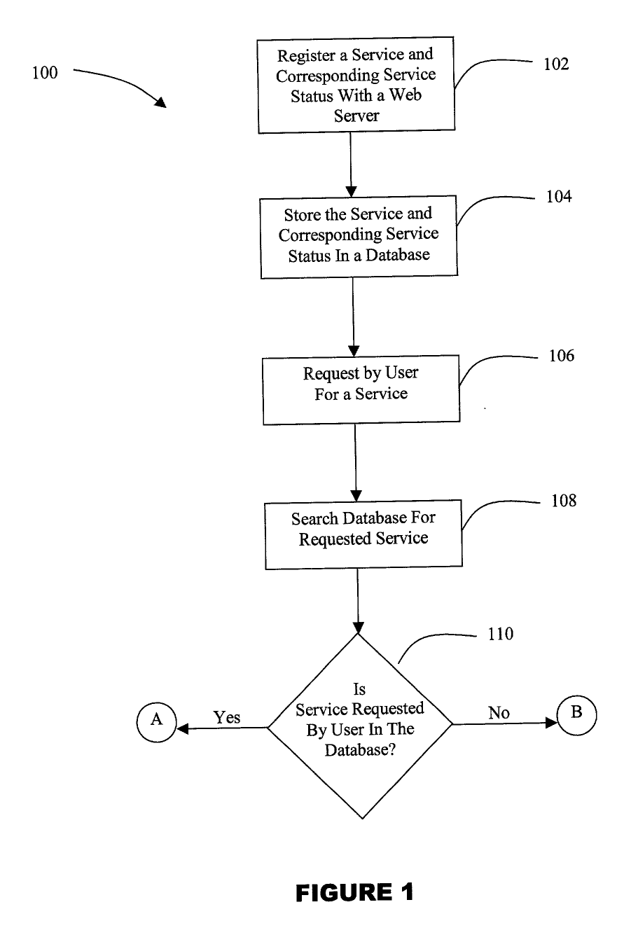

Referring now to FIG. 1, there is illustrated a flowchart of a preferred implementation of a method for obtaining service information over the Internet. The method being generally referred to by reference numeral 100. At step 102, at least one service provider registers a service and corresponding service status with a server. The service status is preferably whether or not the service is available to a user. Service information, such as the service provider's name, address, and phone number are also provided by the service provider. The service provider registers his or her service with the server through an interface such as a Web page. Supplying information to a server through a Web page is well known in the art.

Preferably, a plurality of service providers register their service with the server to build a database of service providers and associated services. The registering of a service can be free or a fee can be charged. At step 104, the service, the service status, and the service information are stored in a database. The database can be at the server or remote therefrom.

At step 106, a user requests a particular desired service from the server. At step 108, the database of registered services is searched for the service requested by the user. At step 110, it is determined whether the service requested by the user is found in the database. If the service requested is found in the database, the method proceeds to branch A, while if the service requested is not found in the database, the method proceeds to branch B.

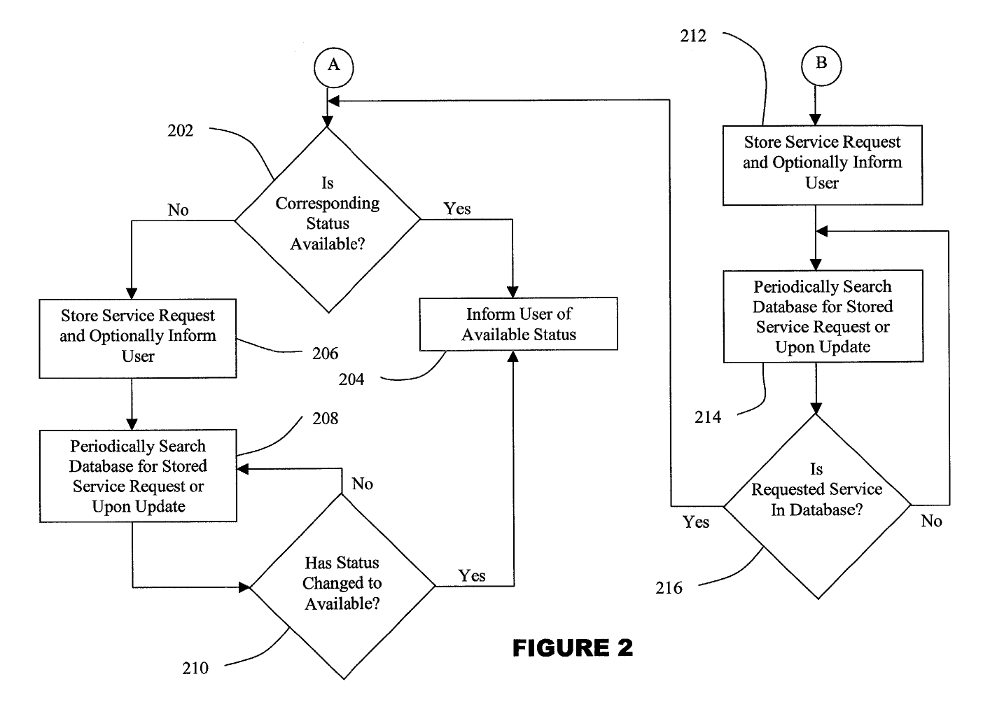

Referring now to FIG. 2, if the requested service is found in the database, the flowchart proceeds to branch A where it is determined at step 202 whether the status corresponding to the service is available. If the status of the requested service is available, the flowchart proceeds to step 204 where the user is informed of the availability of the requested service. The user is also preferably informed of the corresponding service information. Preferably, the user is informed of the service status and service information by sending an e-mail to the user indicating the same. The user's e-mail address is preferably also provided to the server with the service request and is stored in the database corresponding to the request. However, other means for notifying the user may also be supplied and stored, such as a mailing address or phone number. Although the method is described with regard to a single service satisfying the service request, the user is preferably informed of all registered services or a predetermined number of registered services that satisfy the service request.

If the requested service is found on the server and it is determined that the corresponding service status indicates that the service is unavailable, the user is informed at step 206 that the requested service is unavailable. The service request is also preferably stored in a database at step 206 and the user is also informed of the same. Preferably, the user is notified that a service provider meeting his service request is registered but is currently unavailable and that the request is being stored by sending an e-mail to the user.

At step 208, the database is periodically searched for the stored service request and at step 210 it is determined if the service provider has changed the service status from unavailable to available. The database is also searched for any new service providers who have subsequently registered which satisfy the service request. If the service status has been changed to available, the method proceeds to step 204 where the user is notified of the availability of the service provider to meet his or her service request. The preferable means for notifying the user is to send the user an e-mail indicating the availability of the service request along with the service information.

If the status for the service has not changed, the method loops back to step 208 and the database is periodically searched. Although it is preferable for the database to be periodically searched to determine if the service status has changed, other methods are possible. For instance, the changing of a tagged service status from unavailable to available by the service provider could itself trigger the notification of the user of the change.

If the requested service is not found in the database, the flowchart proceeds to branch B to step 212 where the request for the service is stored in a database and the user is informed that the requested service is not registered with the server. The user is also informed that he or she will be informed should a service provider who fulfills the request subsequently registers. Preferably, the user is notified by sending an e-mail to the user indicating the storage of the service request. At step 214, the database is periodically searched for the service request. If the database has been updated and a service that meets the service request is found in the database, the method proceeds to step 202 where the method proceeds as discussed above. If the database has not been updated and a service which meets the service request is still not found in the database, the method proceeds back to step 214.

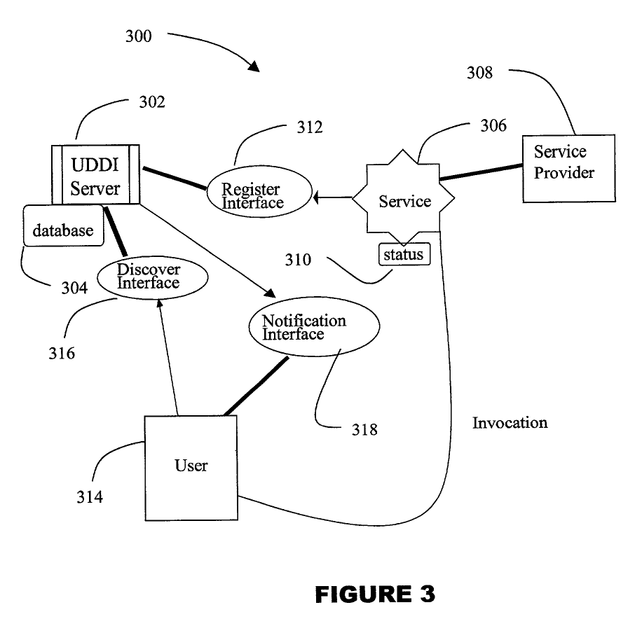

Referring now to FIG. 3, there is illustrated a schematic illustration of a preferred system for practicing the methods of the present invention. The system being generally referred to by reference numeral 300. The system 300 comprises a UDDI server 302 having a memory 304 operatively connected thereto for storing a database of services 306 by a service provider 308 and a service status 310 corresponding to each of the services 306. The service provider 308 registers his or her service 306 and corresponding status 310 with the server 302 through a register interface 312. The register interface 312 is preferably a Web page or e-mail submission. The service provider 308 also registers, if not previously submitted, service information, such as his name, address, and phone number through the register interface 312. The service 306 is preferably stored in the database as a table having fields corresponding to the service status 310, and service information. Looking up information and searching fields from such tables is well known in the art.

The system 300 also includes means for receiving a request for a service by a user 314. Preferably, the user 314 contacts the server 302 through a discover interface 316, such as a Web page or e-mail to make a request for a service. The database is searched for a service provider who has previously registered a service which matches the requested service by the user 314. The user 314 is then informed of the results of the search through a notification interface 318. The notification interface 318 is preferably an e-mail if the user supplies an email address with his or her request.

If a registered service is found which matches the user's request, the user 314 is informed of the match as well as the service status corresponding to the service. If the service status is “available” the user is informed of such and is also informed of the service information. The user is then free to invoke the service 306 of the service provider 308. If the service status is “unavailable” or no match is found for the requested service, the request is preferably stored in the memory 304 and the user 314 is informed of such through the notification interface 318. If the service provider 308 subsequently changes the service status 310 of his or her registered service 306 to “available” through the register interface 312 or if a different service provider registers a service which meets the criteria of the user's stored request, the database is updated accordingly and the user 314 is notified of the update through the notification interface 318.

### EXAMPLES

### Example 1

Tom (user 314) is interested in a service that converts currency of two different countries in a real-time mode. But he couldn't find this service at the UDDI server 302. He hopes that the UDDI server 302 can notify him once a business registers this service. Tom's request is stored in the memory 304 and when a service provider 308 subsequently registers a service 306 for converting currency, the UDDI server 302 notifies him through an e-mail (notification interface 318) of the service provider and his corresponding service information.

### Example 2

A very well known cardiologist (service provider 308) can do a free Web-based screening (service 306) for patients who have heart problems. But the cardiologist 308 only provides such a service when he doesn't have too many regular visiting patients. Therefore, the cardiologist initially registers his screening service with a corresponding service status 310 of “unavailable.” Patients (users 314) can request their interest in the screening service with the UDDI server 302 through the discover interface 316 and are notified that the service is registered but is currently unavailable. The UDDI server will notify these patients 314 once the service status 310 corresponding to the Web-based screening 306 is turned on (changed to “available”) by the cardiologist 308.

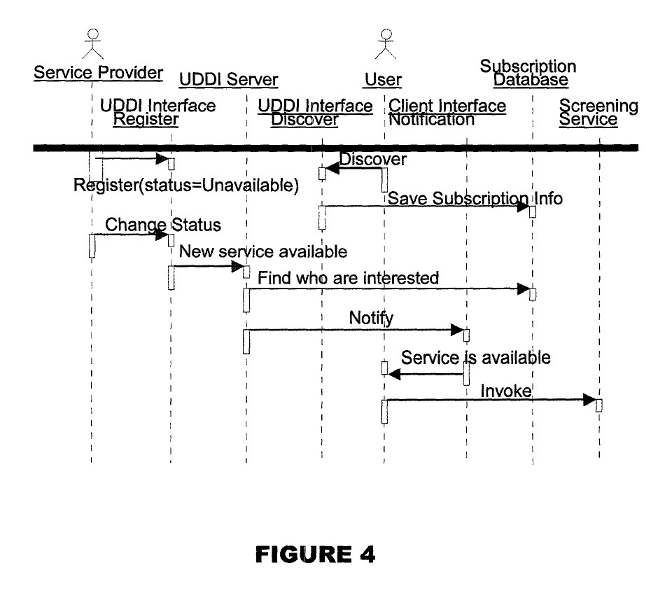

The following scenario based on the Example 2 illustrates how the system 300 components interact with each other. The Cardiologist (service provider 308) registers the service 306 named screening with the UDDI server 302 with a service status 310 of “unavailable.” The Patient (user 314) tries to discover this kind of service from the UDDI server 302 by making a request for the service. The UDDI server 302 couldn't return an available screening service, however, it notifies the user 314 through the notification interface 318 that its request has been stored (subscribed). At a later time, the cardiologist 308 decides he has some free time and he contacts the UDDI server 302 through the register interface 312 to change the service status 310 to “available.” The UDDI server 302 realizes this and notifies the user 314 through the notification interface 318 that the screening service 306 is now available along with other service information such as the name, address, and telephone number of the service provider 308. The user 314 receives the service information and invokes the service. The UML sequence diagram of FIG. 4 shows the detailed message passing among objects in the system for Example 2.

Those skilled in the art will appreciate that enhancing UDDI with a service push model enables users to register for those Web services that are currently unavailable or available only temporarily or at regularly scheduled times. In the preferred methods of the present invention, UDDI provides a set of interfaces for users to register their interests. In addition, a UDDI server has the ability to actively notify a user once a requested service becomes registered or available.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for obtaining service information over the Internet, the method comprising:
at least one service provider registering a service with a server and storing the same in a database;
a user requesting a service from the server;
initially searching the database for the requested service;
updating the database;
subsequently searching the updated database for the requested service; and
notifying the user of the results of the subsequent search.

2. The method of claim 1, further comprising notifying the user of the results of the initial search.

3. The method of claim 2, wherein either of the notifying comprises sending an e-mail to the user.

4. The method of claim 2, wherein the registering further comprises registering a corresponding service status for the service, and if the requested service is found in the database from either the initial or the subsequent search, the corresponding notifying comprises informing the user of the corresponding service status of the requested service.

5. The method of claim 2, wherein if the requested service is not found in the database from either the initial or the subsequent search, the corresponding notifying comprises informing the user that the requested service is not registered with the server.

6. The method of claim 1, further comprising storing the request for the service in the database for the subsequent search.

7. The method of claim 6, further comprising notifying the user that the service request has been stored.

8. The method of claim 7, wherein the notifying that the service request has been stored comprises sending an e-mail to the user indicating the storage of the service request.

9. The method of claim 2, wherein the registering further comprises registering a corresponding service status for the service, and if the requested service is found on the server in the initial search and the service status indicates that the service is available, the corresponding notifying of the initial search results comprises informing the user that the requested service is available.

10. The method of claim 2, wherein the registering further comprises registering a corresponding service status for the service, and if the requested service is found on the server in the initial search and the service status indicates that the service is unavailable, the corresponding notifying of the initial search results comprises informing the user that the requested service is unavailable.

11. The method of claim 10, further comprising storing the request for the service in the database.

12. The method of claim 11, further comprising notifying the user that the service request has been stored.

13. The method of claim 12, wherein the notifying that the service request has been stored comprises sending an e-mail to the user indicating the storage of the service request.

14. The method of claim 1, wherein the registering further comprises registering a corresponding service status for the service, and if the requested service is not found on the server in the initial search but found in the subsequent search and the service status indicates that the service is available, the notifying of the subsequent search results comprises informing the user that the requested service has been found in a subsequent search and is available.

15. The method of claim 1, wherein the registering further comprises registering a corresponding service status for the service, and if the requested service is not found on the server in the initial search but found in the subsequent search and the service status indicates that the service is unavailable, the notifying of the subsequent search results comprises informing the user that the requested service has been found in a subsequent search and is unavailable.

16. The method of claim 1, wherein the updating comprises permitting at least one additional service provider to register with the server.

17. The method of claim 1, wherein the registering further comprises registering a corresponding service status for the service and the updating comprises permitting the at least one registered service provider to change the corresponding service status.

18. A system for obtaining service information over the Internet, the system comprising:
a server having a memory operatively connected thereto for storing a database of services by service providers;
means for receiving a request for a service by a user;
means for initially searching the database for the service request;
means for updating the database;
means for subsequently searching the updated database for the requested service; and
means for notifying the user of the results of the subsequent search.

19. The system of claim 18, further comprising means for notifying the user of the results of the initial search.

20. The system of claim 19, wherein either of the means for notifying comprises means for generating an e-mail and transmitting the same to the user.

21. The system of claim 18, further comprising a memory for storing the request if the requested service is not found in the database in the initial search.

22. The system of claim 18, wherein the means for updating comprises means for permitting at least one additional service provider to register with the server.

23. The system of claim 18, wherein the at least one service provider further registers a corresponding service status for the service and the means for updating comprises means for permitting the at least one registered service provider to change the corresponding service status.
